(19) United States
(12) Patent Application Publication
(10) Pub. No.: US 2006/0074936 A1
(43) Pub. Date: Apr. 6, 2006

(54) Method and system for generating a report using an object-oriented approach

(76) Inventor: Christian A. Behrens, Waldorf (DE)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/956,259

(22) Filed: Sep. 30, 2004

(51) Int. Cl. G06F 7/00

(52) U.S. Cl. 707/100

(57) ABSTRACT

A method to generate a report using an object-oriented approach, including encapsulating a first function and a second function in a first class of objects and a second class of objects respectively. The first class of objects receives a request to generate the report and calls upon the second class of objects. The second class of objects creates data mining objects which are returned to the first class of objects for outputting.

### FIELD OF THE INVENTION

The present invention relates generally to a field of information presentation, and in one embodiment, to generating a report using an object-oriented approach.

### BACKGROUND OF THE INVENTION

One of the most significant developments in computer technology is the development of applications that allow users to harvest and present information from various digital resources, such as the Internet and databases. Information can be presented in numerous ways, for example, an executive summary document, an email, a white paper or a smart form.

Applications such as Microsoft Word, Lotus Notes, Adobe Editor and Netscape Browser create different ways of presenting information. However, these applications define their own output formats, for example, Adobe PDF format, Microsoft Word Document format, Microsoft PowerPoint format and HTML format. As new and more complex applications become available, users may need to have extensive document processing knowledge in order to merge information from multiple applications to achieve the desire document output.

### SUMMARY OF THE INVENTION

According to one aspect of the present invention, there is provided a method to generate a report. The method includes encapsulating a first function and a second function in a first class of objects and a second class of objects respectively, receiving at the first class of objects a request to generate the report, creating a data output object of the first class with a data mining object of the second class and outputting the data output object.

### BRIEF DESCRIPTION OF THE DRAWINGS

The present invention is illustrated by way of example and not limitation in the figures of the accompanying drawings, in which like references indicate similar elements and in which:

FIG. 1 is a network diagram illustrating a system, according to an exemplary embodiment of the present invention, to generate a report using an object-oriented approach;

FIG. 2 is a diagrammatic representation of the structure of an exemplary data mining class and object;

FIG. 3 is a diagrammatic representation of the structure of an exemplary data output class and object;

FIG. 4 is a diagrammatic representation of the data mining object and data output object, in accordance with one exemplary embodiment of the present invention;

FIG. 5 is a flow chart illustrating a method, according to one exemplary embodiment of the present invention, to generate a report using an object-oriented approach;

FIG. 6 is an interaction flow chart illustrating a method, according to one exemplary embodiment of the present invention, to generate a report using an object-oriented approach;

FIG. 7 is a an interaction flow chart illustrating a method, according to another exemplary embodiment of the present invention, to generate a report and an error report using an object-oriented approach; and

FIG. 8 is a diagrammatic representation of a machine within which a set of instructions, for causing the machine to perform any one of methods described herein, may be executed.

### DETAILED DESCRIPTION

A method and a system to generate a report using an object-oriented approach are described. In the following description, for purposes of explanation, numerous specific details are set forth in order to provide a thorough understanding of the present invention. It will be evident, however, to one skilled in the art that the present invention may be practiced without these specific details.

Platform Architecture

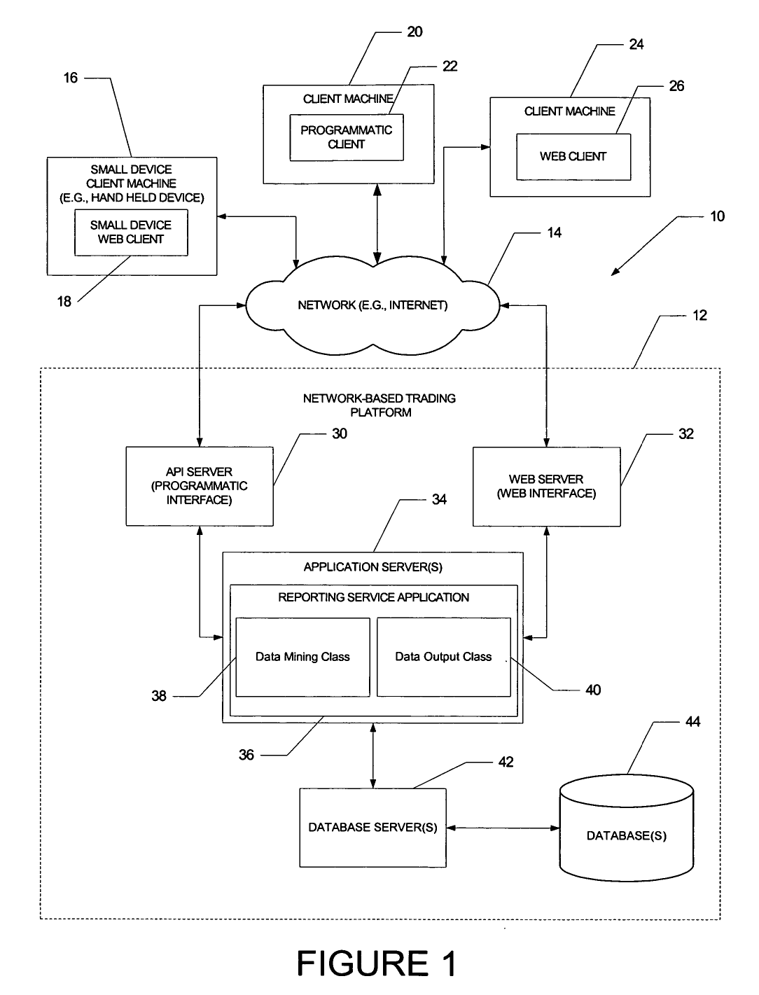

FIG. 1 is a block diagram illustrating a network environment 10, in which one exemplary embodiment of the present invention is shown to be implemented. A platform (e.g., machines and software), in the exemplary form of an enterprise application platform 12, provides server-side functionality via a network 14 (e.g., the Internet) to one or more clients. FIG. 1 illustrates, for example, a small device client machine 16 with a small device web client 18 (e.g., a browser without a script engine), a client machine 20 with a programmatic client 22 and a client machine 24 with web client 26 (e.g., a browser, such as the INTERNET EXPLORER browser developed by Microsoft Corporation of Redmond, Wash. State).

Turning specifically to the enterprise application platform 12, Application Program Interface (API) servers 30 and web server 32 are coupled to, and provide programmatic interfaces and web interface to, application servers 34. The application servers 34 are, in turn, shown to be coupled to one or more databases servers 42 that facilitate access to one or more databases 44. The Application Program Interface (API) servers 30, web servers 32, application servers 34 and database servers 42 host reporting services 36.

The reporting service application 36 provides services to users to manage and output data information. For instance, the reporting service application 36 provides reports in the form of emails or smart forms to users that operate the client machine 16, 20 and 24. The reporting service application 36 further includes data mining class 38 and data output class 40.

While the system 10 shown in FIG. 1 employs a client-server architecture, the present invention is of course not limited to such an architecture, and could equally well find application in a distributed, or peer-to-peer, architecture system.

Class and Object Structure

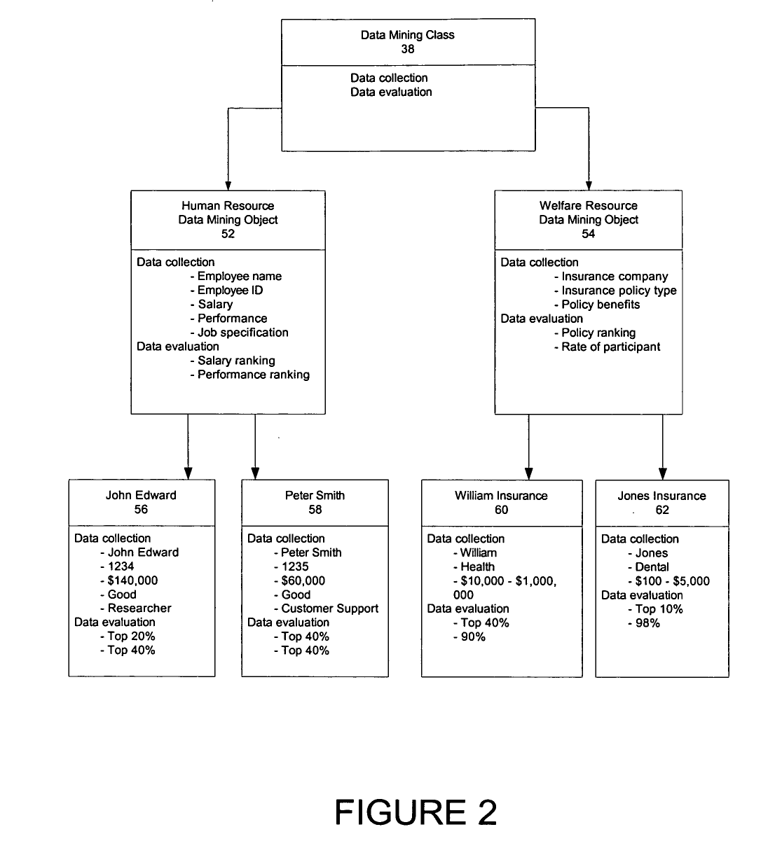

FIG. 2 is a diagrammatic representation of the structure of data mining class 39, data mining objects 52, 54 and instances of data mining objects 56 62, according to one exemplary embodiment of the present invention. The data mining class 38 contains attributes, wherein the attributes define the functions to be performed by the objects belonging to the data mining class 38. That is, an object inherits the attributes of the class. As illustrated in FIG. 2, in one exemplary embodiment, the data mining class 38 contains the functions of data collection and data evaluation. Accordingly, the data mining objects 52-54 of the data mining class 38 inherit the functions of data collection and data evaluation. However, it will be appreciated by one ordinarily skilled in the art that new functions can be programmed for an object to meet the needs of any application. In addition, an object can override an attribute of the class. Therefore, the attributes of an object can be customized accordingly.

The objects of data mining class 38 are further illustrated in FIG. 2 as human resource data mining object 52 and welfare resource data mining object 54, according to one exemplary embodiment of the present invention. The human resource data mining object 52 provides employee's information and the welfare resource data mining object 54 provides insurance company's information.

In one embodiment, the human resource data mining object 52 defines the data collection function to obtain information relating to Employee name, Employee ID, Salary, Performance and Job Specification. In addition, the human resource data mining object 52 performs evaluation on the acquired information for the purpose of salary and performance ranking.

An instance of the human resource data mining object 52 is then created for each employee. For example, object instances 56 and 58 are created for John Edward and Peter Smith respectively. The object instance 56 encapsulates the data information of John Edward which is acquired by performing the data collection function. From the object instance 56, John Edward has an Employee ID 1234, earns $140,000 annually, performs to a grade of good and is a researcher. In addition, the data evaluation function identifies the ranking of John Edward as top 20% in terms of earning salary and top 40% for performance. In the case of object instance 58, Peter Smith has an Employee ID of 1235, earns $60,000 annually, performs to a grade of good and works as a customer support engineer. Peter Smith is ranked top 40% for both salary and performance.

The welfare resource data mining object 54, according to one exemplary embodiment of the present invention, collects data and performs functions relating to the welfare plans offered by various insurance companies. For example, the data collection function of welfare resource data mining object 54 acquires information relating to the Name of the Insurance Company, the Policy Types and Benefits. The welfare resource data mining object 54 also performs functions on the data acquired, such as policy ranking and the rate of participation.

An instance of the welfare resource data mining object 54 is then created for each insurance company. According to one exemplary embodiment, object instances 60 and 62 are created for William Insurance and Jones Insurance respectively. The object instances 60 and 62 both contain the data collection and the data evaluation functions as defined in welfare resource data mining object 54. Object instance 60 provides information of William Insurance which indicates that William Insurance provides health insurance plan and the policy benefit ranges from $10,000-$1,000,000. The health insurance plan of William Insurance is ranked top 40% nationwide and 90% of the employees in the organization are participating in the policy. In another example, object instance 62 contains data information relating to Jones Insurance, showing that Jones Insurance offers dental insurance plan and the policy benefit ranges from $100-$5,000. The data evaluation functions indicate that the dental insurance plan is ranked top 10% nationwide and 98% of the employees took up the policy.

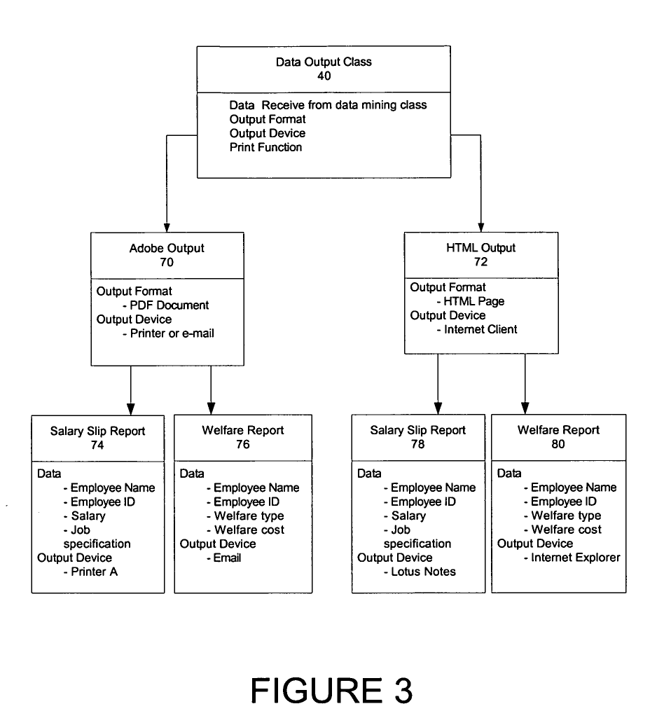

FIG. 3 is a diagrammatic representation of the structure of data output class 40, data output objects 70, 72 and instances of data output objects 74-80, according to one exemplary embodiment of the present invention.

In an exemplary embodiment, the attributes of the data output class 40 enable objects of the data output class 40 to receive data information from data mining objects 52-54 of FIG. 2. In addition, objects of the data output class 40 may perform functions to present the data information in various formats and at various devices.

As illustrated in FIG. 3, in one exemplary embodiment, Adobe output object 70 and HTML output object 72 are objects of the data output class 40. The Adobe output object 70 presents data information in PDF document format and output the document at a printer device or as an email. In another exemplary embodiment, the HTML output object 72 provides data information in HTML page format at an Internet client, such as an Internet browser. FIG. 3 further illustrates that the object instances 74-80 of the Adobe output object 70 and HTML output object 72 generate salary slip report and welfare report.

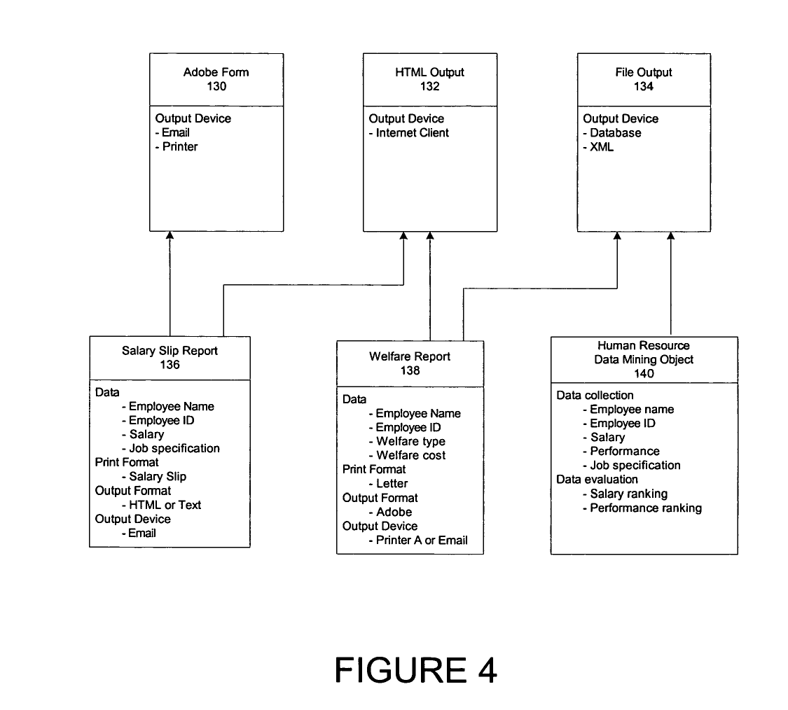

Referring to FIG. 4, in another exemplary embodiment, the data output objects 130-134 generate reports based on the information received from other data output objects 136-138 and/or data mining object 140. For example, the Adobe form data output object 130 receives salary information from salary slip report data mining object 136 and output the data as an Adobe form. In another instance, the same data object 136 may be output as HTML format by calling the HTML data output object 132. This enables the salary slip report data mining object 136 to be generated as two different types of reports without reconfiguring the information and functions.

As illustrated in FIG. 4, the HTML output object 132 may also output the Salary Slip Report data mining object 136 in combination with the Welfare Report data mining object 138. In addition, FIG. 4 provides another exemplary illustration of a File output object 134 that creates a file on database or a XML file from the Welfare Report object 138 and Human Resource Data Mining object 140. In this exemplary embodiment, the File output object 134 obtains data information from objects of different classes.

Object Oriented Approach of Reporting Process

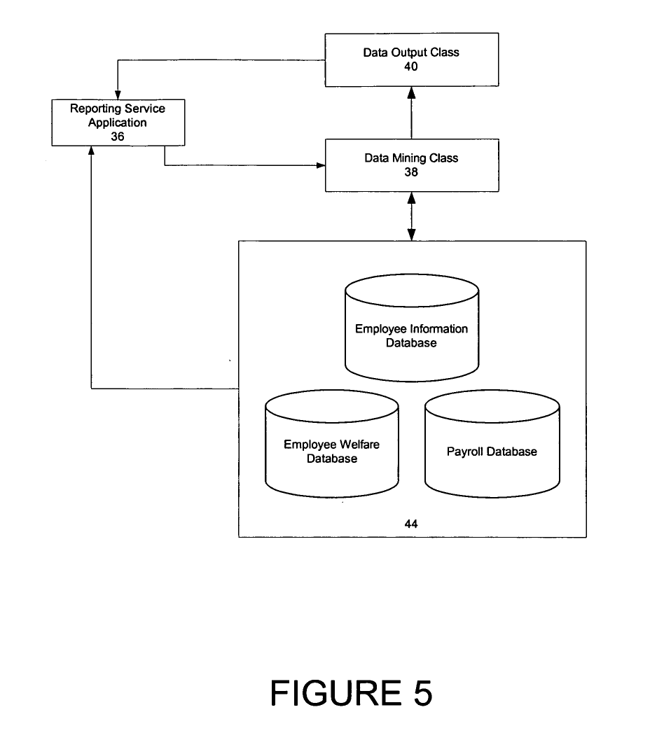

FIG. 5 is a flow chart illustrating a method, according to an exemplary embodiment of the present invention, to communicate data information between the data output class 40 and the data mining class 38 to provide reporting service 36. The process begins with the reporting service application 36 calling on the data mining class 38 with the request to create certain types of report. The data mining class 38 determines the data to be acquired and requests the data from databases 44. As the data mining class 38 receives the data from databases 44, object instances are created for each data entity. The object instances of the data mining class 38 are returned to the data output class 40. The data output class 40 creates the report with the data provided by the object instances of the data mining class 38. The reporting service application 36 get the output result from the data output class 40.

While the exemplary embodiment of the present invention is described as the process beginning with the reporting service application 36 calling the data mining class 38, this is merely an example of one application. The reporting service application 36 may instead call the data output class 40, which in turn communicates the request to the data mining class 38.

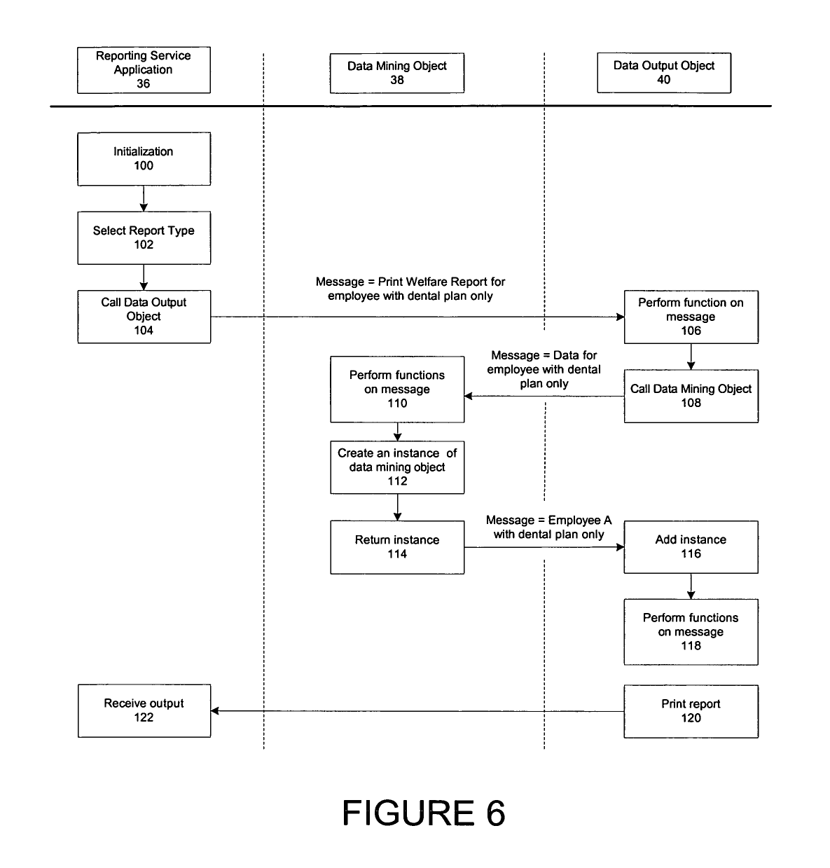

FIG. 6 is an interaction flow chart illustrating a method, according to one exemplary embodiment of the present invention, to generate a report using an object-oriented approach. Starting at block 100, the reporting service application 36 initializes the reporting function at block 100 and selects the type of report to be created at block 102. The reporting service application 36 calls the data output object 38 at block 104 and provides the data output object 40 with the message to generate a report. For example, the message may request the data output object 40 to print a welfare report for employee with dental plan only.

The data output object 40 may perform one or more functions on the message at block 106. The functions may include determining the report type and the data to be generated. Moving on to block 108, the data output object 40 calls the data mining object 38 with the instructions to acquire and evaluate the necessary data information.

At block 110, the data mining object 38 performs the functions on the message received. The functions may include data collection and data evaluation functions encapsulated within the data mining object 38, in one exemplary embodiment of the present invention. For each data entity data collected and evaluated by the data mining object 38, an instance of the data mining object 38 is created in block 112. In one embodiment, an instance of the data mining object 38 is created for each employee that subscribes to the dental plan. The instance of the data mining object 38 is returned to the data output object 40 at block 114.

The data output object 40 receives the instance of the data mining object 38 at block 116. At the next block 118, the data output object 40 performs one or more functions on the information contained in each instance of the data mining object 38. In one example, the functions include printing the report in a desired format and at selected devices. The reporting service application 36 receives the report at block 120.

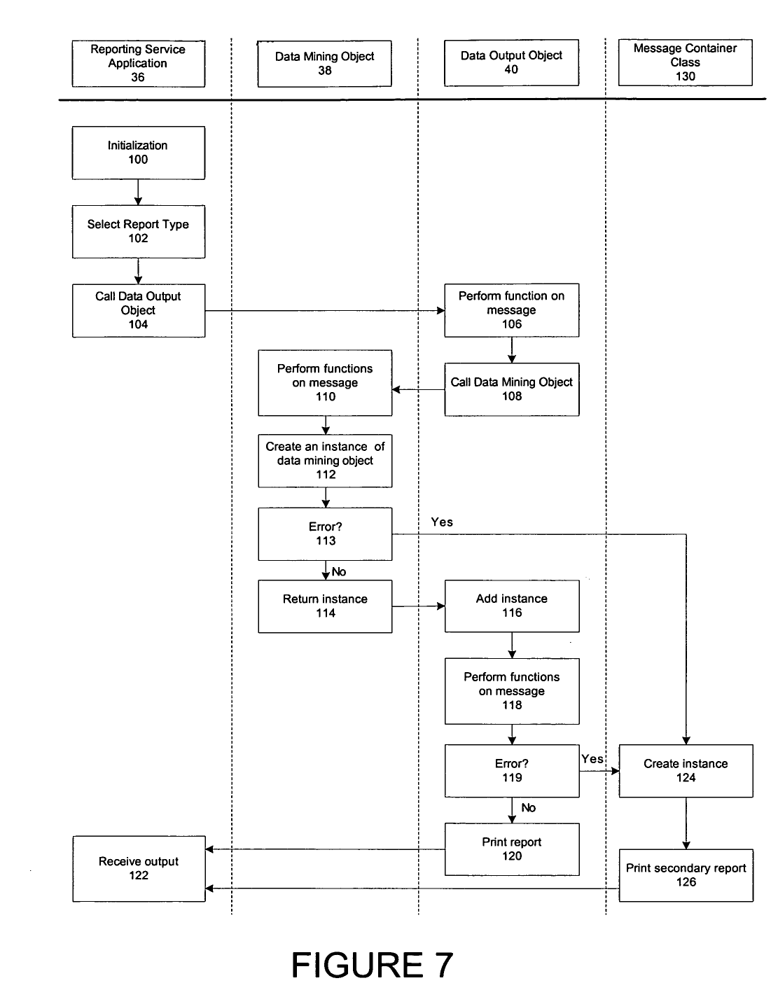

FIG. 7 is an interactive flow chart illustrating a method, according to another exemplary embodiment of the present invention, to generate a report and an error report using an object-oriented approach. The process is similar to the exemplary embodiment as presented in FIG. 6, with the additional function of generating messages, such as error messages in the event when the data mining object 38 or the data output object 40 encounters problem when performing its functions. As illustrated in FIG. 7, an object instance of the message container class 130 is created at block 124 whenever there is an error encountered by the data mining object 38 or the data output object 40.

In one exemplary embodiment, the data mining object 38 makes an error check at block 113 after an instance of the data mining object 38 has been created. If the instance of the data mining object 38 contains error, the data mining object 38 contacts the message container class 130 with the necessary information for the message container class 130 to create the object instance at block 124. In another exemplary embodiment, the data output object 40 performs an error check at block 119 to capture any problems encountered by the data output object 40 when performing its functions at block 118. Similarly, the data output object 40 returns the error to the message container class 130. The message container class 130 prints the secondary report at block 126.

While the message container class 130 is used to provide error notification function in the exemplary embodiment, it will be appreciated by one ordinarily skilled in the art that the message container class 130 can be applied to other purposes. For example, to generate a secondary listing that contains data information that is not selected by the data output object 40 or the data mining object 38. Accordingly, in one exemplary embodiment, report generated at block 120 contains employees who subscribe to dental plan while a secondary report generated at block 126 contains employees who do not have a dental plan.

The above-described exemplary embodiments of the present invention may find application in generating data information in a multitude of scenarios. For example, where the data mining object 38 receives the ticker symbols and stock price information, the above-described embodiments of the present invention could be utilized to communicate the stock price information to the data output object 40. In particular, the data output object 40 may generate the information as a stock alert message or as a financial research report to a user.

In a further use scenario, multiple data mining objects 38 may be used. For instance, a first data mining object collects and evaluates data regarding inventory information while a second data mining object relates to supplier information. A third data mining object then uses the first data mining object and the second data mining object to further create information relating the inventory and the supplier. The data output object 40 receives the information from the third data mining object to generate a relational database or a supplier-inventory report.

System Architecture

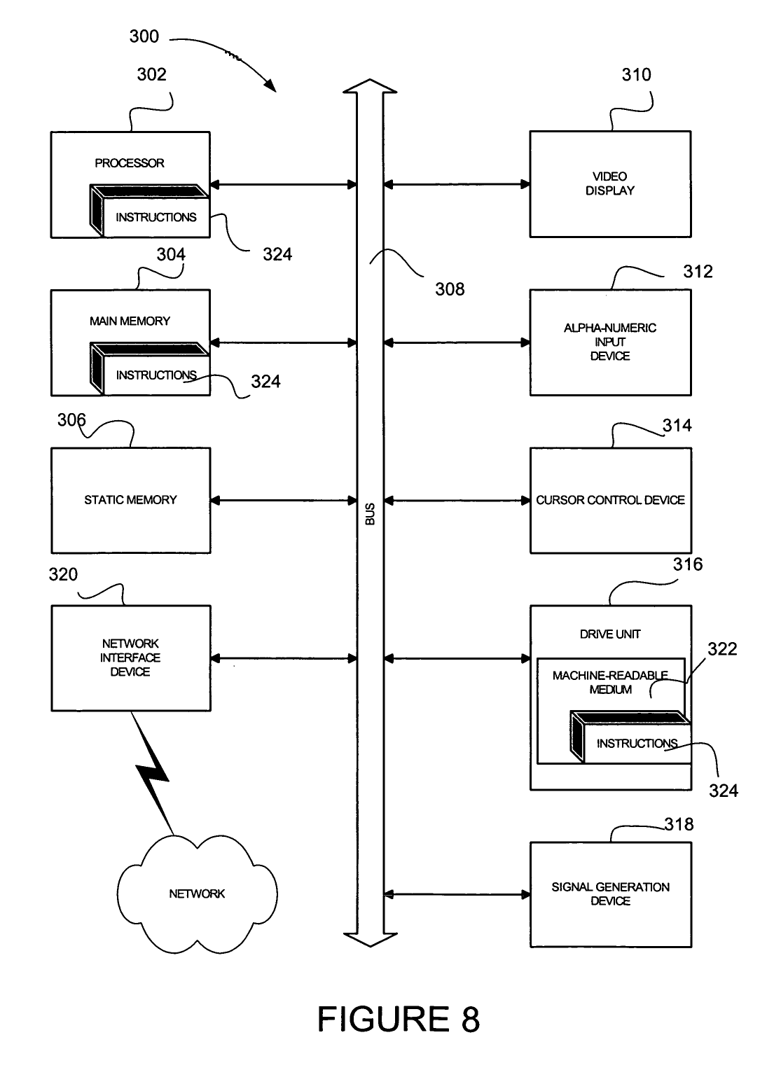

FIG. 8 shows a diagrammatic representation of machine in the exemplary form of a computer system 300 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 300 includes a processor 302 (e.g., a central processing unit (CPU) a graphics processing unit (GPU) or both), a main memory 304 and a static memory 306, which communicate with each other via a bus 308. The computer system 300 may further include a video display unit 310 (e.g., a liquid crystal display (LCD) or a cathode ray tube (CRT)). The computer system 300 also includes an alphanumeric input device 312 (e.g., a keyboard), a user interface (UI) navigation device 314 (e.g., a mouse), a disk drive unit 316, a signal generation device 318 (e.g., a speaker) and a network interface device 320.

The disk drive unit 316 includes a machine-readable medium 322 on which is stored one or more sets of instructions (e.g., software 324) embodying any one or more of the methodologies or functions described herein. The software 324 may also reside, completely or at least partially, within the main memory 304 and/or within the processor 302 during execution thereof by the computer system 300, the main memory 304 and the processor 302 also constituting machine-readable media.

The software 324 may further be transmitted or received over a network 326 via the network interface device 320.

While the machine-readable medium 392 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to included, but not be limited to, solid-state memories, optical and magnetic media, and carrier wave signals.

Thus, a method and system to generate reports using an object-oriented approach have been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. A method for generating a report, the method including:
encapsulating a first function and a second function in a first class of objects and a second class of objects, respectively;
receiving at the first class of objects a request to generate the report;
creating a data output object of the first class with a data mining object of the second class; and
outputting the data output object.

2. The method of claim 1, wherein the encapsulating of the first function and the second function in the first class of objects and the second class of objects further includes encapsulating a data output function in the first class of objects and encapsulating a data mining function in the second class of objects.

3. The method of claim 2, wherein the data output function includes at least one of determining an output format, an output layout and an output device.

4. The method of claim 2, wherein the data mining function includes at least one of acquiring of data from one or more data sources and evaluating of data.

5. The method of claim 4, wherein the one or more data sources is at least one of an existing data mining object, an existing data output object and a digital resource.

6. The method of claim 1, wherein the creating of the data output object of the first class from the data mining object of the second class further includes:
invoking the first class of objects to create the data output object in response to the request;
creating an interface for the first class of objects to request the data mining object from the second class of objects;
invoking the second class of objects to create the data mining object;
returning the data mining object to the first class of objects; and
creating the data output object with the data mining object according to the first function in the first class of objects.

7. The method of claim 1, further including:
encapsulating an error data handling function in a third class of objects;
returning at least one of an erroneous data mining object and an erroneous data output object to the third class of objects;
creating an error object with the at least one of the erroneous data mining object and the erroneous data output object; and
processing the error object according to the error data handling function.

8. The method of claim 7, wherein the error data handling function includes at least one of determining an error type and an error notification process.

9. A system to generate a report, the system including:
a first class of objects to encapsulate a first function and to receive a request to generate the report;
a second class of objects to encapsulate a second function; and
a data output object of the first class to receive a data mining object of the second class and to generate an output.

10. The system of claim 9, wherein the first function is for data output.

11. The system of claim 10, wherein the first function includes at least one of determining an output format, an output layout and an output device.

12. The system of claim 9, wherein the second function is for data mining.

13. The system of claim 12 wherein the second function includes at least one of acquiring of data from one or more data sources and evaluating of data.

14. The system of claim 13, wherein the one or more data sources is at least one of an existing data mining object, an existing data output object and a digital resource.

15. The system of claim 9, wherein the data output object of the first class to receive the data mining object of the second class further includes:
an interface to communicate the request between the first class of objects to the second class of objects;
the second class of objects to create the data mining object and to return the data mining object to the first class of objects;
the first class of objects to create the data output object with the data mining object according to the first function.

16. The system of claim 9, further including:
a third class of objects to encapsulate an error data handling function; and
an error object of the third class to receive at least one of an erroneous data mining object and an erroneous data output object and performs the error data handling function.

17. The system of claim 16, wherein the error data handling function includes at least one of determining an error type and an error notification process.

18. A system to generate a report, the system including:
means for encapsulating a first function and a second function in a first class of objects and a second class of objects, respectively;
means for receiving at the first class of objects a request to generate the report;
means for creating a data output object of the first class with a data mining object of the second class; and
means for outputting the data output object.

19. The system of claim 18, wherein the means for encapsulating of the first function and the second function in the first class of objects and the second class of objects further includes a means for encapsulating a data output function in the first class of objects and a means for encapsulating a data mining function in the second class of objects.

20. The system of claim 19, wherein the data output function includes at least one of determining an output format, an output layout and an output device.

21. The system of claim 19, wherein the data mining function includes at least one of acquiring of data from one or more data sources and evaluating of data.

22. The system of claim 21, wherein the one or more data sources is at least one of an existing data mining object, an existing data output object and a digital resource.

23. The system of claim 18, wherein the means for creating of the data output object of the first class from the data mining object of the second class further includes:
means for invoking the first class of objects to create the data output object in response to the request;
means for creating an interface for the first class of objects to request the data mining object from the second class of objects;
means for invoking the second class of objects to create the data mining object;
means for returning the data mining object to the first class of objects; and
means for creating the data output object with the data mining object according to the first function in the first class of objects.

24. The system of claim 18, further including:
means for encapsulating an error data handling function in a third class of objects;
means for returning at least one of an erroneous data mining object and an erroneous data output object to the third class of objects;
means for creating an error object with the at least one of the erroneous data mining object and the erroneous data output object; and
means for processing the error object according to the error data handling function.

25. The system of claim 24, wherein the error data handling function includes at least one of determining an error type and an error notification process.

26. A machine-readable medium storing a set of instructions that, when executed by machine, cause the machine to generate a report utilizing a method, the method including:
encapsulating a first function and a second function in a first class of objects and a second class of objects, respectively;
receiving at the first class of objects a request to generate the report;
creating a data output object of the first class with a data mining object of the second class; and
outputting the data output object.

27. The machine-readable medium of claim 26, wherein the encapsulating of the first function and the second function in the first class of objects and the second class of objects further includes encapsulating a data output function in the first class of objects and encapsulating a data mining function in the second class of objects.

28. The machine-readable medium of claim 27, wherein the data output function includes at least one of determining an output format, an output layout and an output device.

29. The machine-readable medium of claim 27, wherein the data mining function includes at least one of acquiring of data from one or more data sources and evaluating of data.

30. The machine-readable medium of claim 29, wherein the one or more data source is at least one of an existing data mining object, an existing data output object and a digital resource.

31. The machine-readable medium of claim 26, wherein the creating of the data output object of the first class from the data mining object of the second class further includes:
invoking the first class of objects to create the data output object in response to the request;
creating an interface for the first class of objects to request the data mining object from the second class of objects;
invoking the second class of objects to create the data mining object;
returning the data mining object to the first class of objects; and
creating the data output object with the data mining object according to the first function in the first class of objects.

32. The machine-readable medium of claim 26, further including:
encapsulating an error data handling function in a third class of objects;
returning at least one of an erroneous data mining object and an erroneous data output object to the third class of objects;
creating an error object with the at least one of the erroneous data mining object and the erroneous data output object; and
processing the error object according to the error data handling function.

33. The machine-readable medium of claim 32, wherein the error data handling function includes at least one of determining an error type and an error
